(19) United States
(12) Patent Application Publication
(10) Pub. No.: US 2023/0354759 A1
(43) Pub. Date: Nov. 9, 2023

(54) HYDROPONIC PLANT GROWTH TOWERS USING PVC

(71) Applicant: Hyon Choi, Scottdale, GA (US)

(72) Inventor: Hyon Choi, Scottdale, GA (US)

(21) Appl. No.: 18/222,603

(22) Filed: Jul. 17, 2023

Related U.S. Application Data
(63) Continuation-in-part of application No. 17/245,486, filed on Apr. 30, 2021, now abandoned.
(60) Provisional application No. 63/391,722, filed on Jul. 23, 2022.

(51) Int. Cl. A01G 31/06

(52) U.S. Cl. CPC A01G 31/06; A01G 2031/006

(57) ABSTRACT

A system and method for growing plants by reducing the need for additional water. The hydroponic plant growth system utilizes a reservoir to collect excess water from the support tubes or feeder tubes and refeed the water to the plants through the pump. The water fed to the plants is mixed with nutrient enriched air which is sent directly to the plant roots through the inlets along with the water. This helps the plant absorb the required nutrients and the availability of nutrients is maintained as the water is pumped by the reservoir continuously in this closed loop system.

### CROSS-REFERENCE TO RELATED APPLICATIONS

This U.S. nonprovisional patent application claims priority to U.S. provisional patent application 63/391,722 filed on Jul. 23, 2022 and to U.S. patent application Ser. No. 17/245,486 filed Apr. 30, 2021.

### TECHNICAL FIELD

The present disclosure generally relates to a hydroponic growth system for cultivating plants with less utilization of soil and water.

### BACKGROUND

Agriculture is currently the single largest consumer of fresh water in the world. Since fresh water is always in limited supply, any water used for agriculture is water that we cannot drink or store. Big farms consume so much water that they can run groundwater wells dry, meaning that when drought inevitably strikes, its effects are heightened.

Indoor hydroponic vertical farming practices manage to reduce water consumption by 95% and in some cases, 99%. In addition, on indoor hydroponic vertical farms, crops are vertically placed and piled on top of one another, reducing land use, maximizing space, and increasing productivity per unit area. Because of that, indoor hydroponic vertical farms have the potential to deal with some of the most pressing challenges posed by conventional farming: deforestation and biodiversity loss.

In addition, plants require nutrients such as nitrogen, phosphorus, and potassium, among others. While nutrients like nitrogen are readily available on Earth, plants can only absorb it in the form of nitrates. Farmers use fertilizers to provide plants with nitrogen in this form, but dissolved nitrates that are put into the ground eventually find their way back to the groundwater, which is used for drinking water. Human nitrate consumption can prove toxic to both humans and animals.

Therefore, there is a need for an innovative solution where the water is recycled, limiting the wastage. One in which the nutrients required by the plants are provided without Nitrate insertion into a water table that is used by humans and animals for consumption.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

Accordingly, the present disclosure provides a system that solves the problems described above through an inventive hydroponic gardening system for growing plants. The hydroponic system of the present disclosure utilizes a reservoir that is placed below onto a floor separately and that is connected to the plant holding tubes through support tubes or feeder tubes. Excess water from the plant holding tubes after circulating is received at a reservoir through the support tubes utilizing gravity. Such use makes it easy to recollect the water in the reservoir and feed the water through pumps for recirculation again. In addition to this, air can also be sent to the plant roots from the inlets.

The present disclosure provides a hydroponic plant growth system (i.e., “the system”) for plants which comprises one or more plant holding tubes, wherein the one or more plant holding tubes includes one or more provisions for holding one or more plant saplings. The system also provides at least one reservoir for storing water or liquid, at least one pump for transferring the water or liquid from the reservoir to one or more of the plant holding tubes through one or more feeders or support tubes. The system further provides for at least one light source, wherein the light source emits light required for the growth of one or more of the plant saplings.

There is at least one inlet at the top end of the one or more plant holding tubes. At least one inlet is for passing air, nitrogen, or other gases and nutrients to roots of the plant saplings equipped in the one or more provisions. Finally, provided are one or more holding containers for receiving the water or liquid drained from the one or more plant holding tubes after it is transferred through the pump to the one or more plant saplings through the one or more plant holding tubes, wherein, the one or more feeder or support tubes are angled in a position and are connected to the at least one reservoir for storing the drained water.

Preferably provided is a stand with wheels that securely holds all the components of the hydroponics plant growth system herein. It can be constructed of metal, wood, bamboo, or combinations thereof. When configured this way, the hydroponic plant growth system can be rotated between a vertical and horizontal position.

By recycling water received from the plant holding tubes back at the reservoir, the invention described herein uses up to 90% less water than conventional farming methods. By utilizing a single fluid source and pump to feed multiple plant holding tubes, the present disclosure provides a more efficient use of resources such as water, nutrients, and electricity than comparable other traditional methods or systems.

In practice, the plant holding tubes are made of plastic materials like PVC, hard plastic, or high-density polyethylene. The at least one light source herein can be LED, CFL or any other light emitting device. In use, the holding containers receive drained water through gravity from the one or more plant holding tubes without any additional electronic equipment.

The plant holding tubes herein can be configured into various cylindrical, square or rectangular shapes. Also, the one or more plant saplings herein are placeable into one or more plant containers for ease of accessibility. Containers herein are constructed from a material comprising urethane, rubber, plastic or combinations thereof.

In another embodiment herein, an autonomous hydroponic plant growth system for plants is provided that additionally provides all of the foregoing elements detailed above and adds an autonomous plant growth controller that has a computer grade server. The server is comprised of at least one processor, non-transitory memory coupled to at least one processor, operating software by which to operate the computer grade server, one or more sensors for tracking growth conditions of plants growing within the autonomous hydroponic plant growth system, and a machine learning engine by which this system uses machine learning.

The machine learning engine herein performs the steps of collecting data from the multiple sensors, forming a data set from the collected data, producing an estimate about a pattern in the data set, making a prediction about the data set, evaluating the prediction, optimizing the prediction for accuracy, producing commands for autonomous execution; and either semi-autonomously or autonomously executing the produced commands within the system.

This Summary is provided to introduce a selection of concepts in a simplified form. The concepts are further described in the Detailed Description section. Elements or steps other than those described in this Summary are possible, and no element or step is necessarily required. This Summary is not intended to identify key or essential features of the claimed subject matter, nor is it intended for use as an aid in determining the scope of the claimed subject matter. The claimed subject matter is not limited to implementations that solve any or all disadvantages noted in any part of this disclosure.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates one view of the disclosed hydroponic plant growth system;

FIG. 2 illustrates one view of the disclosed hydroponic plant growth system;

FIG. 3 illustrates one view of the disclosed hydroponic plant growth system;

FIG. 4 illustrates one view of the disclosed hydroponic plant growth system;

FIG. 5 illustrates one view of the disclosed hydroponic plant growth system;

FIG. 6 illustrates one view of the disclosed hydroponic plant growth system; and

FIG. 7 illustrates one view of the disclosed hydroponic plant growth system.

The drawings are not necessarily to scale, and certain features and certain views of the drawings may be shown exaggerated in scale or in schematic in the interest of clarity and conciseness.

### DETAILED DESCRIPTION OF THE INVENTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In the following description, numerous specific details are set forth in order to provide a thorough understanding of the present disclosure. However, it will become obvious to those skilled in the art that the invention may be practiced without these specific details. The description and representation herein are the common meanings used by those experienced or skilled in the art to convey the substance of their work most effectively to others skilled in the art. In other instances, well-known methods, procedures, components, and circuitry have not been described in detail to avoid unnecessarily obscuring aspects of the present disclosure.

Reference herein to “one embodiment” or “an embodiment” or a “variation” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The present disclosure provides a hydroponic plant growth system (i.e., “the system”) for plants which comprises one or more plant holding tubes, wherein the one or more plant holding tubes includes one or more structures for holding one or more plant saplings. The system also provides at least one reservoir for storing water or liquid, at least one pump for transferring the water or liquid from the reservoir to the one or more plant holding tubes through one or more feeders or support tubes. The system further provides for at least one light source, wherein the at least one light source emits light required for the growth of the one or more plant saplings.

There is at least one inlet at the top end of the one or more plant holding tubes, wherein the at least one inlet passes air, nitrogen or other gases and nutrients to roots of the plant saplings equipped in the one or more of the plant holding structures. Also provided are one or more holding containers for receiving water drained from one or more plant holding tubes (i.e., a plant holding structure) after it is transferred through a pump to one or more plant saplings through the one or more plant holding tubes. In practice, one or more feeder or support tubes are angled in a position and are connected to at least one reservoir for storing the drained water. In one embodiment herein, the hydroponic plant growth system comprises components including at least one reservoir, one or more plant holding tubes, one or more feeder tubes, one or more support tubes, one or more pumps and other assisted equipment or parts. The plant holding tubes have one or more inlets to pass air through the water that is fed to the plants in the plant holding tubes.

Also provided is a stand with wheels that securely holds all the components of the hydroponics plant growth system herein. It can be constructed of metal, wood, bamboo, or combinations thereof. When configured this way, the hydroponic plant growth system can be rotated between a vertical and horizontal position.

In the preferred practice herein, the plant holding tubes are made of plastic materials like PVC, hard plastic, and/or high-density polyethylene. The at least one light source herein can be light emitting diode (i.e., LED), compact fluorescent lighting (CFL), or any other light emitting device that is energy efficient. In use, the holding containers receive drained water through gravity from the one or more plant holding tubes without any additional electronic equipment.

The plant holding tubes herein can be configured into various cylindrical, square, or rectangular shapes. Also, the one or more plant saplings herein are positioned into one or more plant containers for ease of accessibility. Containers herein are constructed from a material comprising urethane, rubber, plastic or combinations thereof. Persons of skill in the art will readily recognize that the shape of the plant holding tubes is a matter of design choice and it neither affirms nor negates inventiveness of the embodiments herein.

In another embodiment herein, an autonomous hydroponic plant growth system for plants is provided that additionally provides all of the foregoing elements detailed above and adds an autonomous plant growth controller having a computer grade server comprising at least one processor, non-transitory memory coupled to at least one processor, operating software by which to operate the computer grade server, one or more sensors for tracking growth conditions of plants growing within the autonomous hydroponic plant growth system, and a machine learning engine by which this system uses machine learning.

The machine learning engine herein performs the steps of collecting data from the multiple sensors, forming a data set from the collected data, producing an estimate about a pattern in the data set, making a prediction about the data set, evaluating the prediction, optimizing the prediction for accuracy, producing commands for autonomous execution; and either semi-autonomously or autonomously executing the produced commands within the system.

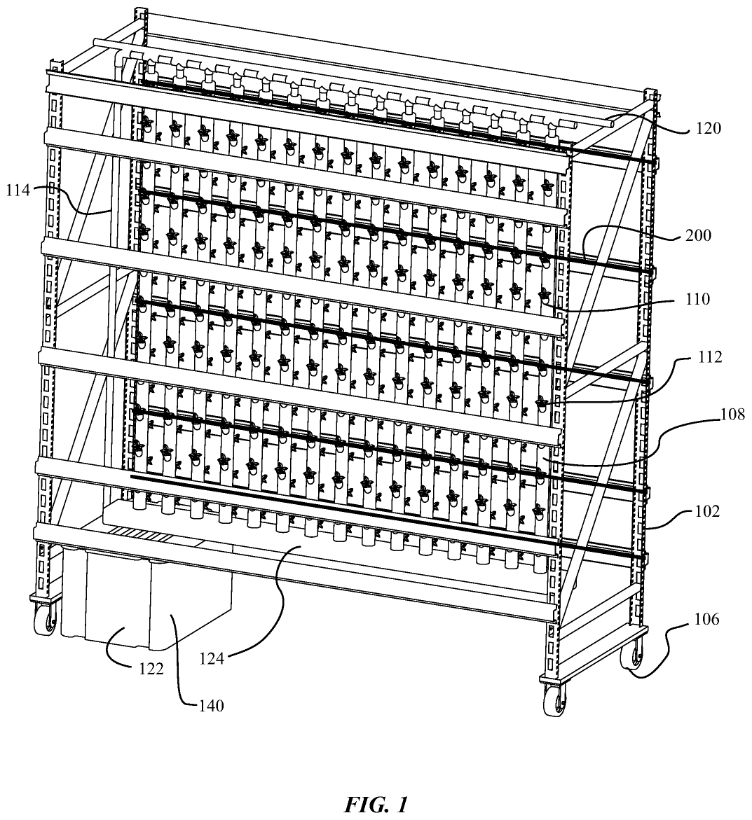

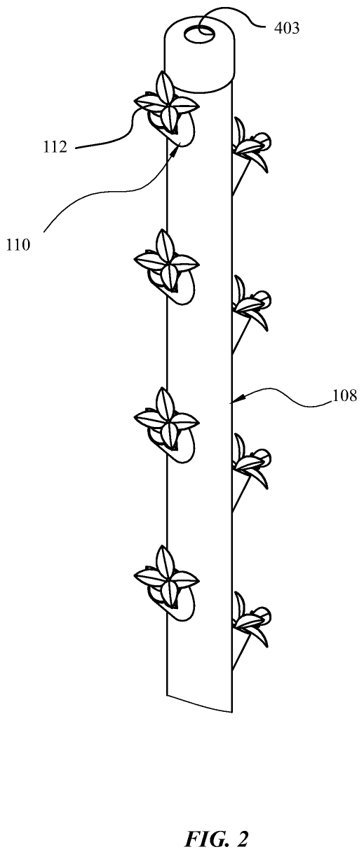

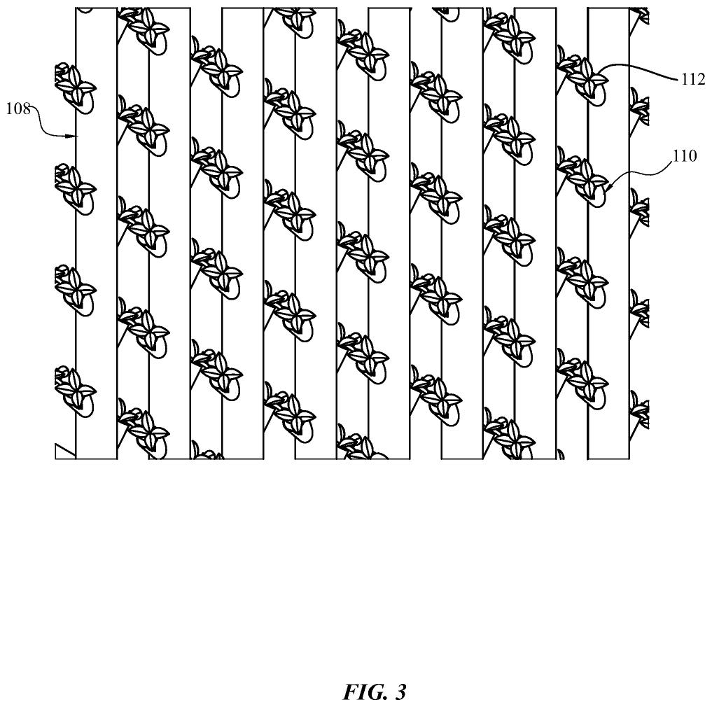

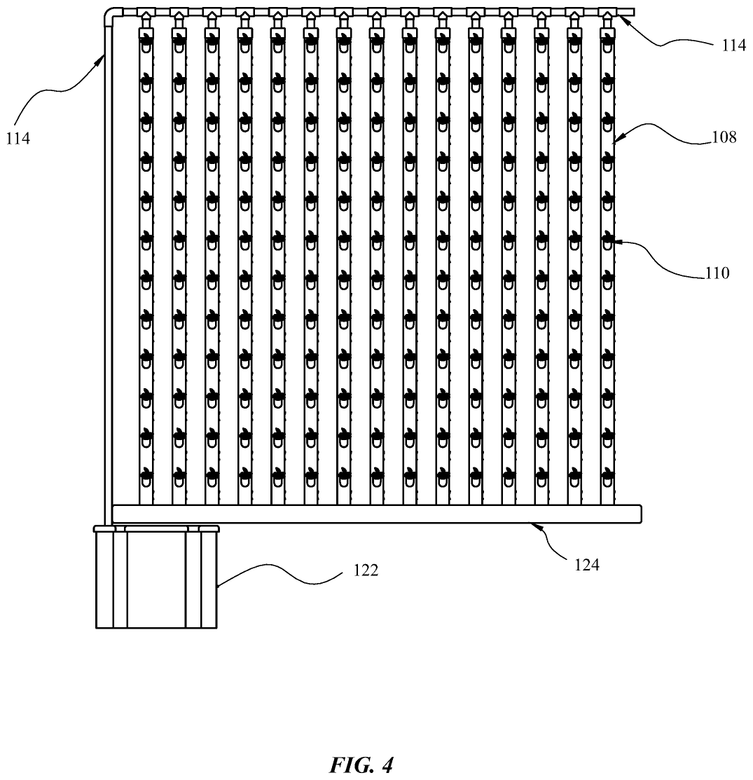

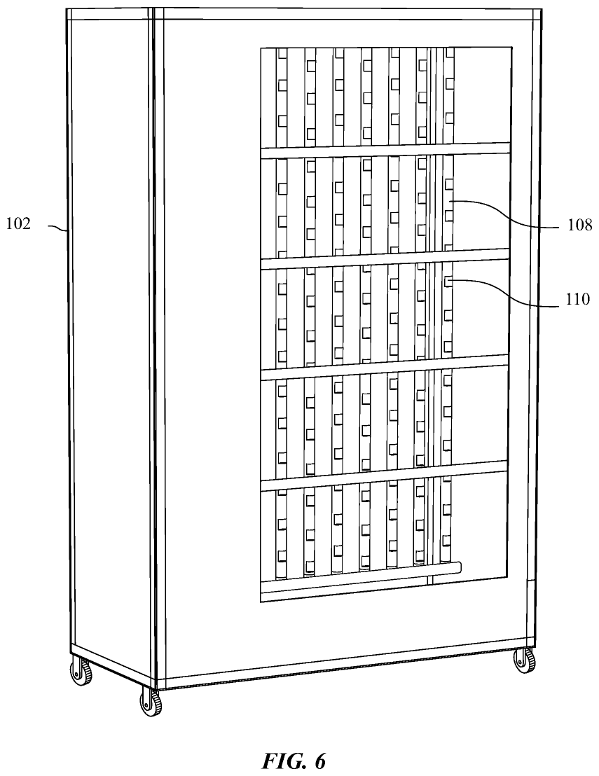

FIGS. 1-7 illustrate embodiments of the hydroponic plant growth system that utilizes reservoir 122 which is connected to a stand or frame 102 to store water. The frame 102 may include castors 106 or wheels for relocation. Water with nutrients is pumped, via pump 140 within the reservoir 122, to the plant saplings 112 in plant holders 110 at the plant holding tubes 108 through the feeder tubes 114, 120. After circulating, the excess water from the plant holding tubes 108 is collected at the water return tray 124 placed below the plant holding tubes 108 utilizing gravity and the excess water is further transferred to the reservoir 122.

This makes it easy to recollect the water in the reservoir 122 and feed the water through pumps 140 or other alternatives. In addition to this, air can also be sent to the plant roots from the inlets. By recycling water received from the plant holding tubes 108 back at the reservoir 122, the invention described herein uses up to 90% less water than conventional farming methods. By utilizing a single fluid source and pump to feed multiple plant holding tubes 108, the present disclosure provides a more efficient use of resources such as water, nutrients and electricity than comparable alternative traditional methods or systems.

In one embodiment, the hydroponic plant growth system comprises several components as shown in FIG. 1-7. The components include reservoir 122, plant holding tubes 108, feeder tubes 114, 120, pump 140, and other assisted equipment or parts. Plant holding tubes 108 comprise inlets 403 that pass air and nutrients through the water that is fed to the plants placed in the plant holders 110 formed in the plant holding tubes 202.

In some embodiments, water is collected through gravity at the bottom after passing through the plant roots by the water return tray 124 that is placed in a slanted position and connected to the reservoir 122. The reservoir 102 receives the excess water directly without need of any other additional components or parts. This allows the collection of the excess water without utilizing any electricity and reduces the need for electricity in the entire system.

Arrays of plant holding tubes 108 or growth tubes are provided with an overhead mounted hydroponic fertigation system delivering metered intermittent flows of water with fertigation recycling, insulated mixing and holding tanks and an insulated thermoplastic distribution piping system to maintain fertigation temperatures near those of natural ground water.

In some implementations, plant holding tubes 108 are designed to hold the plants firmly and the plant holding tubes 108 are aligned in a vertical position to implement gravity based excess water collection.

In yet another embodiment herein, additional nutrients are mixed into the water and supplied to the plant roots through one or more pumps which are present in the reservoir 140. Additionally, a mixture of air containing nitrogen and oxygen is also passed to the plant roots through the inlets 403 present at one side of the plant holding tubes 108.

In another embodiment herein, plant saplings 112 are placed into the plant holders 110 created in one or more plant holding tubes 108 using natural or artificial soil in predetermined quantities. The soil helps the plant hold its grip while each is held in a vertical position within plant holding tubes 108.

Polyvinyl chloride (i.e., PVC), a material used herein, is a synthetic thermoplastic material made by polymerizing vinyl chloride. The properties depend on the added plasticizer. The flexible forms are used in hosepipes, insulation, shoes, and garments. Rigid PVC is used for molded articles. Additionally, plant holders 110 created to hold the plants inside of plant holding tubes 108 are prepared by cutting and bending the PVC at an angle which helps strongly hold the plants while placed in various positions and angles.

An artificial light source 200 is used to provide the necessary light to the plants in the hydroponic plant growth system. Suitable artificial light sources include LED, CFL or any other light emitting equipment other than Natural light.

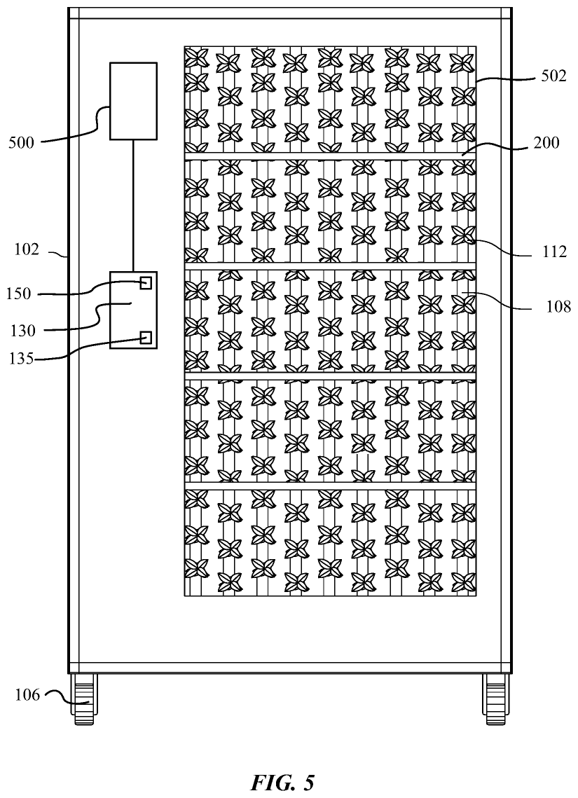

In another embodiment herein, hydroponic plant growth system is also designed to utilize natural light via a glass or plexiglass window, depicted as 502 in FIG. 5, in addition to the artificial light source 200. In another embodiment, as depicted in FIG. 5, the hydroponic plant growth system includes various electronic components like sensors 150, all of which may be connected to, and thereby send data/information to either machine learning engine 135 and/or controller 130, or a temperature control system 500 including heating, cooling, and humidity control configurations. The route of data/information to either machine engine 135 and/or controller 130 depends entirely upon whether machine learning engine 135 exists within hydroponic plant growth system 100. According to some embodiments, the controller 130 may be in operable communication with the sensors 110, light source 200, temperature control system 500, and pump 140 and may be configured for controlling the flow of fluid, light, and temperature or humidity controls.

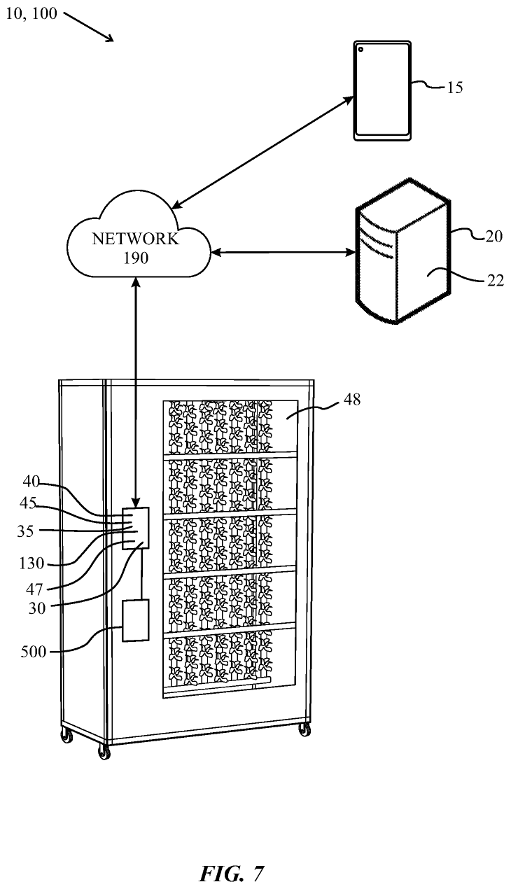

FIG. 7 is a schematic of an alternative system herein for plant growth disclosed. It is a representation of the totality of system 10 as described herein. Shown is personal mobile device 15, indicating the addition of the user interface software that enables a user (e.g., farmer) to operate system 10. Also shown is server 20 in operable connection with the controller 130 over a network 190.

A user's personal mobile device 15 is used to interact with system 10 to direct it and to learn from it. Personal mobile device 15 contains software with a usable graphical interface. This software allows a user to interact with system 10 and controller 130, send instructions to it, pull data from it, and make changes (i.e., executable commands) where necessary. By use of the software, a user can remain in operative communication with server 20.

Server 20 also comprises software, not necessarily graphical, that receives and interprets instructions sent from personal mobile device 15 and then sends executable commands to the components (i.e., controller 25, relay board 30, etc.) of system 10. Importantly, server 20 also comprises a substantial amount of memory. The memory of server 20 is critical to the effective operation of system 10 because, over time, the system accumulates many terabytes of data that enable a machine learning feature thereof. Since machine learning is highly data dependent, acquisition and storage thereof are paramount.

FIG. 7 includes pest control system 48. As part of the work done by plant growth system 10, controlling the kinds of pests attracted to plants grown within system 10 is paramount. These include rodents, birds, insects and weeds. Pest control system 48 is configured herein to limit or eliminate the presence of all types of pests that would normally destroy growing plants within plant growing system 10.

The ideal pest control system 48 herein should be readily usable by system 10 and independently actuated by the system especially when it operates autonomously.

In some embodiments, a pump herein has an attached filter that filters the watering solution before it is supplied to the plant saplings. In yet another embodiment, a spray nozzle may be provided at the top of stand which disperses the watering solution to the plurality of plants; specifically, the plant medium and roots. In some embodiments, multiple spray nozzles are provided at various heights along hydroponic plant growth system 100, improving the delivery of watering solution to the plurality of plant saplings. Preferably, the plant medium is a soilless medium including, but not limited to, coconut choir, lightweight expanded clay aggregate (LECA), rock wool, perlite, or any combination of the disclosed mediums.

Preferably, the spray nozzle delivers a fine mist to the plurality of plant saplings. Yet in another embodiment, the spray nozzle delivers small droplets to the plurality of plants. In some embodiments, a timer is provided to control the watering schedule. The timer is adjusted to provide a predetermined amount of watering solution to the plurality of plants at specific time intervals which is a well-known practice in the art.

In some embodiments, a soil mixture may be placed at the top of hydroponic plant growth system such that when the spray nozzle delivers water to the plurality of plants, the water is dripped through the soil providing nutrients to the plants. In one embodiment, a particle filter is provided at one or more of the holding containers herein. The particle filter is comprised of mesh filter sections designed to prevent roots and other large pieces, such as growing medium materials from entering holding containers.

Holding containers returns to reservoir through support tubes. The particle filter may be constructed of any shape including, but not limited to, cylindrical, rectangular, and spherical. The particle filter may include any number of mesh filter sections on the top, bottom, and sides of the filter. Although the particle filter is illustrated at a distance from the bottom surface of holding containers, in some embodiments, the particle filter is flush with the bottom surface of holding containers to prevent a build-up of liquid or watering solution.

In some embodiments, the plant saplings are equipped within hydroponic plant growth system 100 and are placed in the provisions created in plant holding tubes. Plant holding containers may also be designed to equip special plant saplings.

In another embodiment, provisions have an angled or oval shape, and are spaced at various locations in plant holding tubes. Plant holding tubes may have growth strips constructed of a net or mesh like material that are filled with a growing medium, preferably a growing medium designed for starting seeds.

The hydroponics plant growth system is a pot-less vertical hydroponic system which has many advantages, including a quicker seeding process as it would be less time consuming to place seeds in the growth strip prior to placement inside the provisions in plant holding tubes compared to preparing individual plant containers. Likewise, the harvesting process is more efficient and less time consuming in comparison to harvesting and removing each individual plant container.

After passing through the plant roots, the water is collected by gravity at the bottom by support tubes that are placed in a slanted position and connected to reservoir which receives any and all excess water directly without the need of any other additional components or parts. This allows for the collection of the excess water without utilizing any electricity and reduces the need for electricity in the whole system. Plant holding tubes are designed to hold the plants firmly and are aligned in a vertical position to implement gravity based excess water collection.

In another embodiment, additional nutrients are mixed into the water and supplied to the plant roots through the pump present in reservoir. Additionally, nitrogen or oxygen mixed air is also passed to the plant roots through the inlet present at one side of a plant holding tube.

In another embodiment, PVC material is used in the various tubes of hydroponic plant growth system. Additionally, the provisions created to hold the plants in plant holding tubes are prepared by cutting and bending the plant holding tube at an angle which helps secure the plants while they are placed in various positions and angles.

In another embodiment, an artificial light source is used to provide the necessary light to the plants in the hydroponic plant growth system. The artificial light source used may be LED, CFL, or any other light emitting equipment other than natural light. In another embodiment herein, the hydroponic plant growth system is designed to utilize natural light outdoors and utilize artificial light while indoors. Hydroponic plant growth system herein may also include various electronic components like sensors, wires, indicators, and the like to improve the system and generate various alerts relevant to the system.

Embodiments herein may also include computer program products for use in the systems of the present disclosure, the computer program product having a physical computer readable program code stored thereon. The computer readable program code comprises of computer executable instructions that causes the system to perform the methods of the present disclosure when they are executed by a processor.

Sensors herein include but are not limited to the following: pH sensor, temperature sensor, humidity sensor, carbon dioxide sensor, pressure sensor, level sensor, and the like. Persons of skill in the art will be familiar with all the various kinds of sensors used for plant growth and/or farming and will also understand that choice of sensor forms no part of the invention herein.

In most or all instances herein, the sensors used by system are all of the smart sensor variety. A smart sensor is a device that takes input from the physical environment and uses built-in computer resources to perform predefined functions upon detection of specific input and then processes data before passing it on. Smart sensors enable more accurate and automated collection of environmental data with less erroneous noise amongst the accurately recorded information. These devices are used for monitoring and control mechanisms in a wide variety of environments including smart grids, battlefield reconnaissance, exploration and many scientific applications.

Computer resources are typically provided by low-power mobile microprocessors. At a minimum, a smart sensor is made of a sensor, a microprocessor, and a communication technology of some kind. The computer resources must be an integral part of the physical design—a sensor that just sends its data along for remote processing is not considered a smart sensor.

A smart sensor herein may also include other components besides the primary sensor. These components can include transducers, amplifiers, excitation control, analog filters and compensation. A smart sensor also incorporates software-defined elements that provide functions such as data conversion, digital processing and communication to external devices.

In practice, a smart sensor ties a raw base sensor to integrated computing resources that enables the sensor's input to be processed. The base sensor is the component that provides the sensing capability. It might be designed to sense heat, light or pressure. Often, the base sensor will produce an analog signal that must be processed before it can be used. This is where an intelligent sensor's integrated technology comes into play. The onboard microprocessor filters out signal noise and converts the sensor's signal into a usable, digital format.

Smart sensors of the kind used herein also contain integrated communications capabilities that enable them to be connected to a private network or to the internet. This enables communication to external devices.

The sensors herein are not base sensors. A base sensor is simply a sensor that is not equipped with a DMP or other computer resources that would enable it to process data. Whereas a smart sensor produces output that is ready to use, a base sensor's output is raw and must typically be converted into a usable format.

Smart sensors include an embedded Digital Motion Processor (DMP), whereas base sensors do not. A DMP is essentially a microprocessor that is integrated into the sensor. It enables the sensor to perform onboard processing of the sensor data. This might mean normalizing the data, filtering noise or performing other types of signal conditioning. A smart sensor performs data conversion digital processing prior to any communication to external devices.

Smart sensors are generally preferred over base sensors because they include native processing capabilities. Even so, there are situations where it might be more advantageous to use a base sensor. If an engineer is designing a device and needs complete control over sensor input, then it will make more sense to use a base sensor than a smart sensor. Base sensors also cost less than smart sensors because they contain fewer components.

Controller herein is a device controller that handles the incoming and outgoing signals of server as directed by the central processing unit (i.e., “CPU”) therein. Herein, controller controls the signals sent to and the actions made by relay board, plant watering system, climate control system, lighting system, plant nutrient adjustment system and all devices attached to and included therewith. Persons of skill in the art will readily recognize that all devices that are part of all of the aforementioned systems can be attached either by hard wire or wirelessly, the nature of said attachment not forming a part of the inventive system(s) herein. Each such device within the systems herein contain mechanical and electrical parts. In practice, controller uses binary and digital codes to communicate with each system, i.e., so-called ‘machine language’.

Controller is a hardware unit operatively attached to the I/O bus of server and works like an interface between a device and a device driver. It is an electronic device consisting of microchips that is responsible for managing the incoming and outgoing signals of the CPU.

The systems and methods herein preferably use machine learning. Machine learning (ML) involves the use and development of computer systems that can learn and adapt without direct human intervention, by using algorithms and statistical models to analyze and draw inferences from patterns in data and then make choices thereby.

Machine learning is a branch of artificial intelligence (AI) and computer science that focuses on the use of data and algorithms to imitate the way that humans learn, gradually improving its accuracy. Machine learning is a key component of the growing field of data science. By using statistical methods, algorithms are trained to make classifications or predictions, uncovering key insights within data mining projects.

The critical elements of machine learning analysis are all the following: data set; one or more algorithms; data models; feature extraction (as applied to the data); and training of a system in which machine learning is applied.

The term “data set” is defined herein as a collection of data pieces that can be treated by a computer as a single unit for analytical and predictive purposes. The term “algorithm” as used herein is defined as a mathematical or logical program that turns a data set into a model. The term “model” or “models” as used herein is defined as a computational representation of real-world processes. The term “feature extraction” as used herein is a process of transforming raw data into numerical features that can be processed while preserving the information in the original data set. The term “training” as used herein means one or more approaches that allow machine learning models to identify patterns and make decisions.

In practice, machine learning comprises three main functions: 1) a decision process; 2) an error function; and 3) a model optimization process. In general, machine learning algorithms are used to make a prediction or classification. Based on input data, which can be labelled or unlabeled, your algorithm will produce an estimate about a pattern in the data. An error function serves to evaluate the prediction of the model. If there are known examples, an error function can make a comparison to assess the accuracy of the model. If the model can fit better to the data points in the training set, then weights are adjusted to reduce the discrepancy between the known example and the model estimate. The algorithm will repeat this evaluative and optimization process, updating weights autonomously until a threshold of accuracy is met.

Herein, a machine learning engine is provided that uses the following steps:
1. Collecting data from the multiple sensors;
2. Forming a data set from the collected data;
3. Producing an estimate about a pattern in the data set;
4. Making a prediction about the data set;
5. Evaluating the prediction; and then
6. Optimizing the prediction for accuracy of overall system operation.

The collected data comes from any one of the provided sensors shown in FIG. 1, a group of them, or all of them. Sensors are in place to monitor all plant growth within the system continuously. Data from sensors is placed into data sets usable by machine learning engine.

In practice, machine learning engine resides within the non-transitory memory of server and is in operable communication with the sensors. In practice, raw data flows from sensors into the non-transitory memory housed within server and is then treated and segregated by machine learning engine. Once the raw data from sensors is collected, machine learning engine then produces an estimate about a pattern in the data set. In other words, machine learning engine looks for patterns in the raw data and logs them.

After an estimate is produced, machine learning engine makes one or more predictions about the trend of the data in order to adjust or otherwise manipulate plant watering system, climate control system, lighting system, and/or plant nutrient adjustment system.

For example, once an estimate is produced, existing water levels may be compared to a known norm in water levels. System can then calculate appropriate remedial action, if necessary, based upon a calculated prediction (i.e., that is at least partially reliant on historical data acquisition stored in one or more databases for reference by machine learning engine) of where water levels will trend given a) no action to remediate and/or b) appropriate action to remediate an existing deficit.

Before the prediction is relied upon to execute action by system, it can be evaluated by machine learning engine. Methods of evaluation are statistical and can include classification accuracy, logarithmic loss, confusion matrix, area under curve, F1 score, mean absolute error, and mean squared error.

“Accuracy” typically refers to classification accuracy. It is the ratio of the number of correct predictions to the total number of input samples. Log-loss is indicative of how close the prediction probability is to the corresponding actual/true value (0 or 1 in case of binary classification). The more the predicted probability diverges from the actual value, the higher the log-loss value. A confusion matrix is a table that is used to define the performance of a classification algorithm. A confusion matrix visualizes and summarizes the performance of a classification algorithm.

Area Under Curve (AUC) is one of the most widely used metrics for evaluation. It is used for binary classification problems. The AUC of a classifier is equal to the probability that the classifier will rank a randomly chosen positive example higher than a randomly chosen negative example. F1 Score is the Harmonic Mean between precision and recall. The range for an F1 Score is [0, 1]. It tells one how precise a known classifier is (i.e., how many instances it classifies correctly), as well as how robust it is—it does not miss a significant number of instances. Mean absolute error is the average of the difference between the original values and the predicted values. It provides the measure of how far the predictions were from the actual output. However, it does not provide any idea of the direction of the error, (i.e., whether the system under predicts or over predicts the data).

Once all predictions for all measurables (e.g., water level, nutrient level, lighting levels, temperature, humidity, and the like) have been evaluated, the next step is to optimize the predictions for use. “Prediction” refers to the output of an algorithm after it has been trained on a historical dataset and applied to new data when forecasting the likelihood of a particular outcome.

System herein is autonomous which means that the system self-adjusts and executes commands without human intervention. System's self-adjustment derives from optimization of the prediction(s) created by machine learning engine. Upon optimization of the prediction(s) for accuracy, system next produces one or more commands for adjustment to system; (i.e., plant watering system, climate control system, lighting system and/or plant nutrient adjustment system). Ideally, system is both self-governing and self-actuating. “Self-governing” refers to the fact that system can continuously evaluate itself and issue commands (or make recommendations) for action. “Self-actuating” refers to the fact that system 100 can execute commands generated from its calculated optimized predictions on its own.

The intent of an autonomous system 100 herein is that it substantially operates without human hands or intervention. More specifically, plant watering system 35, climate control system 40, lighting system 45 and plant nutrient system 47 are meant, in a fully autonomous system 100, to be controlled and operated solely by server 20. This level of autonomous operability is especially important for large scale farming in which many other functions are also automated including harvesting machines, fruit pickers and the like. It is also important in farming and/or plant growing conditions where human labor is sparse or nonexistent except for the minimal handling and maintenance of system 100.

In practice, the minimal handling and maintenance of system 100 requires a qualified person(s) to maintain and repair each of the critical plant growth systems (i.e., plant watering system 35, climate control system 40, lighting system 45 and plant nutrient adjustment system 47). This person(s) would ensure that an ample water supply is provided, adequate plant nutrients fill the system therefore, and the like. If one of the critical systems that make up system 100 breaks, one or more humans is expected to repair it. If server 20 goes off-line, a human operator must analyze it and provide a remedy.

Semi-autonomous operation of system herein means that the system self-adjusts and executes commands without human intervention. System's self-adjustment derives from optimization of the prediction(s) created by machine learning engine 22. Upon optimization of the prediction(s) for accuracy, system 100 next produces one or more commands for adjustment to system 100; (i.e., plant watering system 35, climate control system 40, lighting system 45 and/or plant nutrient adjustment system 47). Ideally, system 100 is at least partially self-governing but not self-actuating. “Self-governing” refers to the ability of system 100 to continuously evaluate itself and issue commands (or make recommendations) for action. “Self-actuating” refers to the fact that system 100 can execute commands generated from its calculated optimized predictions but in an instance where system 100 is semi-autonomous, one or more human operators execute command recommendations created proffered by machine learning engine 22.

The intent of a semi-autonomous system 100 herein is that it operates partially without human hands or intervention. More specifically, plant watering system 35, climate control system 40, lighting system 45 and plant nutrient system 47 are meant, in a semi-autonomous system 100, to be only partially controlled and operable by server 20 but also controlled and manipulated by human hands (i.e., human workers/operators).

Importantly, the degree of semi-autonomy of system 100 can be adjusted. Once recommendations for action are provided by machine learning engine 22, human operators can then decide to what degree to execute those recommendations. For example, with machine learning engine recommendations in hand, human operators can choose to personally manage each of the major systems herein (i.e., plant watering system 35, climate control system 40, lighting system 45 and/or plant nutrient adjustment system 47), one of them or fewer than all four of them. Regardless of the choice of degree of semi-autonomy of system 100, any human operator manipulation of one or more of the major systems causes system 100 herein to be semi-autonomous.

In one embodiment, the detectors are configured to analyze plants and can be trained using a machine learned model. A detector can detect a predetermined set of visual features of the plants and provide analysis to a user for decision making.

In one embodiment, the detectors can also be machine-created, software-based detectors wherein they identify the requirements of the system or the user and provide data accordingly. The system, through machine learning, trains and manages detectors. By using machine learning, the system is self-learning. A detector can be configured to search for a particular set of data items. In various embodiments, the system creates the detectors by training one or more machine learning models using training data. The training data includes example data items provided by a user. The training data can include positive examples and/or negative examples. A positive example includes desired features, and a negative example includes undesired characteristics.

The system can autonomously or semi-autonomously self-adjust it choice(s) based upon past and current plant growth performance and/or criteria irrespective. In practice, the system tracks and records all data generated from the various sensors and monitors other gathered historical data. All this information is stored to memory in one or more computer grade servers. The system can then reference the historical data for future evaluation of optimal plant growth.

The present disclosure may be embodied as systems, methods, apparatus, computer readable media, non-transitory computer readable media and/or computer program products. The present disclosure may take the form of an entirely hardware embodiment, an entirely software embodiment (including firmware, resident software, micro-code, etc.) or an embodiment combining software and hardware aspects that may all be referred generally herein as a “circuit,” “module” or “system.” The present disclosure may take the form of a computer program product embodied in one or more computer readable medium(s) having computer readable program code embodied thereon.

One or more computer readable medium(s) may be utilized, alone or in combination. The computer readable medium may be a computer readable storage medium or a computer readable signal medium. A suitable computer readable storage medium may be, for example, an electronic, magnetic, optical, electromagnetic, infrared, or semiconductor system, apparatus, or device, or any suitable combination of the foregoing. Other examples of suitable computer readable storage medium include, without limitation, the following: an electrical connection having one or more wires, a portable computer diskette, a hard disk, a random access memory (RAM), a read-only memory (ROM), an erasable programmable read only memory (EPROM or flash memory), an optical fiber, an optical storage device, a magnetic storage device, or any suitable combination of the foregoing. A suitable computer readable storage medium may be any tangible medium that can contain or store a program for use by or in connection with an instruction execution system, apparatus, or device.

A computer readable signal medium may include a propagated data signal with computer readable program code embodied therein such as in, for example, baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, Python, C++, or the like, and conventional procedural programming languages, such as the “C” programming language or similar programming languages. The program code may execute entirely on the user's computing device (such as, a computer), partly on the user's computing device, as a stand-alone software package, partly on the user's computing device and partly on a remote computing device or entirely on the remote computing device or server. In the latter scenario, the remote computing device may be connected to the user's computing device through any type of network, including a local area network (LAN) or a wide area network (WAN), or through an external computing device (for example, through the Internet using an Internet Service Provider).

The present disclosure described herein with reference to flowchart illustrations and/or block diagrams can be implemented by computer program instructions. These computer program instructions may be provided to a processor of a general purpose computing device, such as a computer, special purpose computing device, or other programmable data processing apparatus to produce a machine, such that the instructions, which execute via the processor of the computing device or other programmable data processing apparatus, create a means for implementing the functions/acts specified in the flowchart and/or block diagram block(s).

These computer program instructions may also be stored in a computer readable medium that can direct a computing device, other programmable data processing apparatus, or other devices to function in a particular manner, such that the instructions stored in the computer readable medium produce an article of manufacture including instructions that implement the function specified in the flowchart and/or block diagram block(s).

The computer program instructions may also be loaded onto a computing device, other programmable data processing apparatus, or other devices to cause a series of operational steps to be performed on the computing device, other programmable apparatus or other devices to produce a computer implemented process such that the instructions which execute on the computing device or other programmable apparatus provide processes for implementing the functions specified in the flowchart and/or block diagram block(s).

It should be appreciated that the function blocks or modules shown in the drawings illustrate the architecture, functionality, and operation of possible implementations of systems, methods and computer program media and/or products according to various embodiments of the present disclosure. In this regard, each block in the drawings may represent a module, segment, or portion of code, which comprises one or more executable instructions for implementing the specified logical function(s). It should also be noted that, in some alternative implementations, the functions noted in the block may occur out of the order noted in the figures. For example, the function of two blocks shown in succession may, in fact, be executed substantially concurrently, or the blocks may sometimes be executed in the reverse order depending upon the functionality involved.

It will also be noted that each block and combinations of blocks in any one of the drawings can be implemented by special purpose hardware-based systems that perform the specified functions, or combinations of special purpose hardware and computer instructions. Also, although communication between function blocks or modules may be indicated in one direction on the drawings, such communication may also be in both directions.

The present disclosure may be embodied in other specific forms without departing from its spirit or essential characteristics. The described embodiments are to be considered in all respects only as illustrative and not restrictive. The scope of the invention is, therefore, indicated by appended claims rather than by the foregoing description. All changes which come within the meaning and range of equivalency of the claims are to be embraced within their scope.

What is claimed is:

1. A hydroponic plant growth system, comprising:
one or more plant holding tubes, wherein the one or more plant holding tubes includes one or more provisions for holding one or more plant saplings;
at least one reservoir for storing water or liquid;
at least one pump for transferring the water or liquid from the reservoir to the one or more plant holding tubes through one or more feeder or support tubes;
at least one light source, wherein the at least one light source emit light required for the growth of the one or more plant saplings;
at least one inlet at top end of the one or more plant holding tubes, wherein the at least one inlet is for passing the air, nitrogen, or other gases to the roots of the plant saplings equipped in the one or more provisions; and
one or more holding containers for receiving the water or liquid drained from the one or more plant holding tubes after it is transferred through the pump to the one or more plant saplings through the one or more plant holding tubes, wherein, the one or more feeder or support tubes are angled in a position and are connected to the at least one reservoir for storing the drained water.

2. The hydroponic plant growth system of claim 1, wherein a stand with wheels securely holds all the components of the hydroponics plant growth system are placed inside.

3. The hydroponic plant growth system of claim 2, wherein the hydroponic plant growth system can be rotated between a vertical and horizontal position.

4. The hydroponic plant growth system of claim 1, wherein the plant holding tubes are made of plastic materials like PVC, hard plastic, or high-density polyethylene.

5. The hydroponic plant growth system of claim 1, wherein the at least one light source can be LED, CFL or any other light emitting device.

6. The hydroponic plant growth system of claim 1, wherein the holding containers receive drained water through gravity from the one or more plant holding tubes without any additional electronic equipment.

7. The hydroponic plant growth system of claim 1, wherein the plant holding tubes can be in various cylindrical, square, or rectangular shapes.

8. The hydroponic plant growth system of claim 1, wherein the one or more plant saplings are equipped into one or more plant containers for easy accessibility.

9. The hydroponic plant growth system of claim 8, wherein the one or more plant containers are constructed from a material comprising urethane, rubber, plastic or combinations thereof.

10. The hydroponic plant growth system of claim 2, wherein the stand is made of materials like metal, wood, bamboo or combinations thereof

11. An autonomous hydroponic plant growth system for plants, comprising:
one or more plant holding tubes, wherein the one or more plant holding tubes includes one or more provisions for holding one or more plant saplings;
at least one reservoir for storing water or liquid;
at least one pump for transferring the water or liquid from the reservoir to the one or more plant holding tubes through one or more feeder or support tubes;
at least one light source, wherein the at least one light source emit light required for the growth of the one or more plant saplings;
at least one inlet at top end of the one or more plant holding tubes, wherein the at least one inlet is for passing the air, nitrogen, or other gases to the roots of the plant saplings equipped in the one or more provisions;
one or more holding containers for receiving the water or liquid drained from the one or more plant holding tubes after it is transferred through the pump to the one or more plant saplings through the one or more plant holding tubes, wherein, the one or more feeder or support tubes are angled in a position and are connected to the at least one reservoir for storing the drained water; and
an autonomous plant growth controller comprising:
at least one computer processing unit;
non-transitory memory coupled to said at least one processor;
operating software by which to operate the at least one computer processing unit;
one or more sensors for tracking growth conditions of plants growing within said autonomous hydroponic plant growth system,
a machine learning engine performing the steps of:
collecting data from said multiple sensors;
forming a data set from said collected data;
producing an estimate about a pattern in said data set;
making a prediction about the data set;
evaluating said prediction;
optimizing the prediction for accuracy;
producing commands for autonomous execution; and
autonomously executing said commands within system.

12. The autonomous hydroponic plant growth system for plants as in claim 11, further comprising a computer server operably connected to said autonomous plant growth controller.

13. The autonomous hydroponic plant growth system for plants as in claim 11, further comprising a relay board operatively connected to said autonomous plant growth controller.

14. The autonomous hydroponic plant growth system for plants as in claim 11, further comprising multiple sensors for monitoring plant growth within said plant growing area, said multiple sensors being operatively connected to said machine learning engine and delivering collected data to said machine learning engine.

15. The autonomous hydroponic plant growth system for plants as in claim 11, further comprising a plant watering system positioned about said plant growing area, said plant watering system being operatively connected to said relay board.

16. The autonomous hydroponic plant growth system for plants as in claim 11, further comprising a climate control system positioned about said plant growing area, said climate control system being operatively connected to said relay board.

17. The autonomous hydroponic plant growth system for plants as in claim 11, further comprising a lighting system positioned about said plant growing area, said lighting system being operatively connected to said relay board.

18. The autonomous hydroponic plant growth system for plants as in claim 11, further comprising a plant nutrient delivery system positioned about said plant growing area, said plant nutrient delivery system being operatively connected to said relay board.

19. The autonomous hydroponic plant growth system for plants as in claim 11, further comprising a personal wireless device having a graphical interface for use by a user wherein said personal wireless device is in operative communication with said system to grow plants through said graphical interface.

20. An autonomous hydroponic plant growth system for plants, comprising:
one or more plant holding tubes, wherein the one or more plant holding tubes includes one or more provisions for holding one or more plant saplings;
at least one reservoir for storing water or liquid;
at least one pump for transferring the water or liquid from the reservoir to the one or more plant holding tubes through one or more feeder or support tubes;
at least one light source, wherein the at least one light source emit light required for the growth of the one or more plant saplings;
at least one inlet at top end of the one or more plant holding tubes, wherein the at least one inlet is for passing the air, nitrogen, or other gases to the roots of the plant saplings equipped in the one or more provisions;
one or more holding containers for receiving the water or liquid drained from the one or more plant holding tubes after it is transferred through the pump to the one or more plant saplings through the one or more plant holding tubes, wherein, the one or more feeder or support tubes are angled in a position and are connected to the at least one reservoir for storing the drained water; and
an autonomous plant growth controller comprising:
at least one computer processing unit;
non-transitory memory coupled to said at least one processor;
operating software by which to operate the at least one computer processing unit;
one or more sensors for tracking growth conditions of plants growing within said autonomous hydroponic plant growth system,
a machine learning engine performing the steps of:
collecting data from said multiple sensors;
forming a data set from said collected data;
producing an estimate about a pattern in said data set;
making a prediction about the data set;
evaluating said prediction;
optimizing the prediction for accuracy;
producing commands for autonomous execution; and
autonomously executing said commands within system;
a computer server operably connected to said autonomous plant growth controller;
a relay board operatively connected to said autonomous plant growth controller;
multiple sensors for monitoring plant growth within said plant growing area, said multiple sensors being operatively connected to said machine learning engine and delivering collected data to said machine learning engine;
a plant watering system positioned about said plant growing area, said plant watering system being operatively connected to said relay board;
a climate control system positioned about said plant growing area, said climate control system being operatively connected to said relay board;
a lighting system positioned about said plant growing area, said lighting system being operatively connected to said relay board; and
a plant nutrient delivery system positioned about said plant growing area, said plant nutrient delivery system being operatively connected to said relay board.
